(19) United States
(12) Patent Application Publication
(10) Pub. No.: US 2025/0247005 A1
(43) Pub. Date: Jul. 31, 2025

(54) BUCK-BOOST REGULATOR WITH PASS THROUGH MODE AND THE METHOD THEREOF

(71) Applicant: Chengdu Monolithic Power Systems Co., Ltd., Chengdu (CN)

(72) Inventor: Yi Zhang, Chengdu (CN)

(21) Appl. No.: 19/036,794

(22) Filed: Jan. 24, 2025

(30) Foreign Application Priority Data
Jan. 26, 2024 (CN) 202410114757.7

(51) Int. Cl. H02M 3/158

(52) U.S. Cl. CPC H02M 3/1582

(57) ABSTRACT

A buck boost converter with pass through mode is discussed. The buck boost converter may operate at buck mode, boost mode, buck-boost mode, and pass through mode based on different input voltage and output voltages. A control circuit periodically controls the power switches to operate at a refresh mode when the buck boost converter operates at the pass through mode. Thus, the bootstrap voltages that are used to drive the N-type power switches are timely charged.

### CROSS-REFERENCE TO RELATED APPLICATIONS

This application claims priority to and the benefit of Chinese Patent Application No. 202410114757.7, filed Jan. 26, 2024, which is incorporated herein by reference in its entirety.

### BACKGROUND OF THE INVENTION

A buck boost converter is typically used in an application having a wide input voltage range and a wide output voltage range. FIG. 1 schematically shows a typical circuit topology of a buck-boost converter 100. As shown in FIG. 1, the buck-boost converter 100 comprises: a first high-side switch Q1, a first low-side switch Q2, a second low-side switch Q3, a second high-side switch Q4, and an inductor L. The first high-side switch Q1 is coupled between an input voltage Vin and a first switch node SW1. The first low-side switch Q2 is coupled between the first switch node SW1 and a reference ground. The second low-side switch Q3 is coupled between a second switch node SW2 and the reference ground. The second high-side switch Q4 is coupled between the second switch node SW2 and an output voltage Vo. The inductor L is coupled between the first switch node SW1 and the second switch node SW2. When the input voltage Vin is higher than the output voltage Vo, the buck boost converter 100 is controlled to operate at buck mode: the second low-side switch Q3 is maintained to be OFF, the second high-side switch Q4 is maintained to be ON, and the first high-side switch Q1 and the first low-side switch Q2 are controlled to be ON and OFF alternately. When the input voltage Vin is lower than the output Vo, the buck boost converter 100 is controlled to operate at boost mode: the first low-side switch Q2 is maintained to be OFF, the first high-side switch Q1 is maintained to be ON, the second high-side switch Q4 and the second low-side switch Q3 are controlled to be ON and OFF alternately. When the input voltage Vin and the output voltage Vo having a voltage difference lower than a certain voltage value, the buck boost converter is controlled to operate at buck-boost mode: the first high-side switch Q1 and the first low-side switch Q2 are controlled to turned on and off alternately; and the second high-side switch Q4 and the second low-side switch Q3 are also controlled to turned on and off alternately. When the input voltage Vin and the output voltage Vo are close to each other, the buck boost converter is controlled to operate at a pass through mode: the first high-side switch Q1 and the second high-side switch Q4 are maintained to be ON, and the first low-side switch Q2 and the second low-side switch Q3 are maintained to be OFF.

If the first high-side switch Q1 and the second high-side switch Q4 both adopt an N type transistor, a bootstrap (floating) capacitor is needed, to raise a voltage at a control terminal of the transistor. The maintained-ON status of the first high-side switch Q1 and/or the maintained-ON status of the second high-side switch Q4 would cause a voltage drop across the bootstrap capacitor, which may trigger under voltage protection and cause the converter to exit from normal operation.

### SUMMARY OF THE INVENTION

In accordance with an embodiment of the present invention, a buck boost converter is discussed. The buck boost converter comprises: an input pin, a first switch pin, a first bootstrap pin, an output pin, a second switch pin, a second bootstrap pin, and a control circuit. The input pin is configured to receive an input voltage. The first switch pin is configured to receive the input voltage via a first power switch and coupled to a reference ground via a second power switch. The first bootstrap pin is configured to provide a first bootstrap voltage to the first power switch. The output pin is configured to provide an output voltage. The second switch pin is coupled to the reference ground via a third power switch and to the output pin via a fourth power switch. The second bootstrap pin is configured to provide a second bootstrap voltage to the fourth power switch. The control circuit has a bootstrap refresh circuit and a control signal generator. When the buck boost converter operates at a pass through mode, the bootstrap refresh circuit is configured to regularly generate a refresh clock signal, and the control signal generator is configured to generate a first control signal, a second control signal, a third control signal, and a fourth control signal in response to the refresh clock signal and a mode indicate signal, to respectively control the first power switch, the second power switch, the third power switch, and the fourth power switch.

In addition, in accordance with an embodiment of the present invention, a buck boost converter is discussed. The buck boost converter comprises: an input pin, a first switch pin, a first bootstrap pin, an output pin, a second switch pin, a second bootstrap pin, and a control circuit. The input pin is configured to receive an input voltage. The first switch pin is configured to receive the input voltage via a first power switch and coupled to a reference ground via a second power switch. The first bootstrap pin is configured to provide a first bootstrap voltage to the first power switch. The output pin is configured to provide an output voltage. The second switch pin is coupled to the reference ground via a third power switch and to the output pin via a fourth power switch. The second bootstrap pin is configured to provide a second bootstrap voltage to the fourth power switch. The control circuit has a bootstrap manage circuit, coupled to the first switch pin, the first bootstrap pin, the second switch pin, and the second bootstrap pin, to monitor a undervoltage condition of the first bootstrap voltage and the second bootstrap voltage. When at least one of the first bootstrap voltage and the second bootstrap voltage has the undervoltage condition, the bootstrap manage circuit is configured to control the first power switch to fourth power switch to operate at a refresh mode.

Furthermore, in accordance with an embodiment of the present invention, a method used in a buck boost converter is discussed. The buck boost converter has a first power switch, a second power switch, a third power switch, and a fourth power switch. The method comprises: providing a first bootstrap voltage to the first power switch, providing a second bootstrap voltage to the fourth power switch; controlling the buck boost converter to operate at different modes based on an input voltage and an output voltage; and if the buck boost converter operates at a pass through mode, periodically controlling the first power switch to the fourth power switch to operate at a refresh mode; or if the buck boost converter operates at the pass through mode and an undervoltage condition occurs at least one of the first bootstrap voltage and the second bootstrap voltage, controlling the first power switch to the fourth power switch to operate at the refresh mode.

### BRIEF DESCRIPTION OF DRAWINGS

FIG. 1 schematically shows a typically circuit topology of a buck-boost converter 100.

FIG. 2 schematically shows a circuit configuration of a buck boost converter 200 in accordance with an embodiment of the present invention.

FIG. 3 schematically shows timing waveforms of the first bootstrap voltage V_{BST1}, the first control signal G_{Q1} to the fourth control signal G_{Q4} under the refresh mode in accordance with an embodiment of the present invention.

FIG. 4 schematically shows a circuit configuration of the buck boost converter 400 in accordance with an embodiment of the present invention.

FIG. 5 schematically shows a circuit configuration of the buck boost converter 500 with a circuit configuration of the bootstrap manage circuit 202 in accordance with an embodiment of the present invention.

FIG. 6 schematically shows timing waveforms of the first bootstrap voltage V_{BST1}, the first control signal G_{Q1} to the fourth control signal G_{Q4} under the refresh mode in accordance with another embodiment of the present invention.

FIG. 7 schematically shows a flowchart 700 of a method used in a buck boost converter in accordance with an embodiment of the present invention.

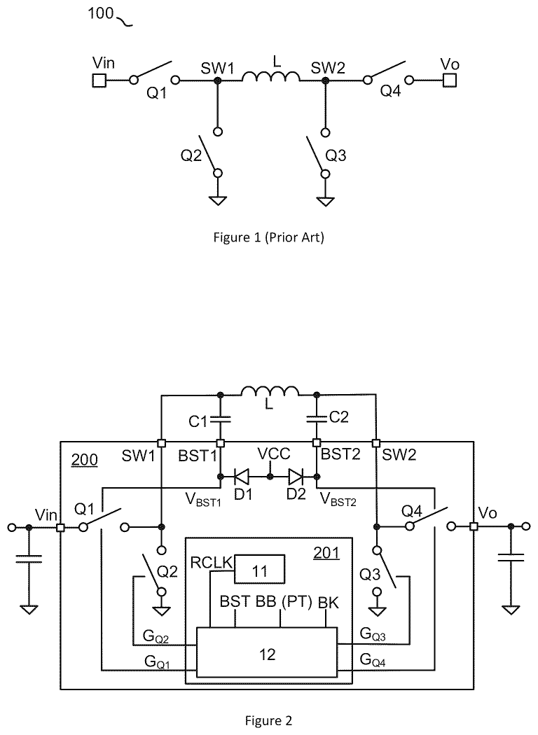

### DETAILED DESCRIPTION OF THE INVENTION

Embodiments of circuits for buck boost converter are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

FIG. 2 schematically shows a circuit configuration of a buck boost converter 200 in accordance with an embodiment of the present invention. In the example of FIG. 2, the buck boost converter 200 comprises: an input pin Vin, a first switch pin SW1, a first bootstrap pin BST1, an output pin Vo, a second switch pin SW2, a second bootstrap pin BST2, and a control circuit 201.

The input pin Vin is configured to receive an input voltage. The first switch pin SW1 is configured to receive the input voltage via a first power switch Q1 and is coupled to a reference ground via a second power switch Q2. The first bootstrap pin BST1 is configured to provide a first bootstrap voltage V_{BST1} to the first power switch Q1 (e.g. the first bootstrap voltage V_{BST1} is delivered to the first power switch Q1 by way of a first driver (not shown)). The output pin Vo is configured to provide an output voltage. The second switch pin SW2 is coupled to the reference ground via a third power switch Q3 and is coupled to the output pin Vo via a fourth power switch Q4. The second bootstrap pin BST2 is configured to provide a second bootstrap voltage V_{BST2} to the fourth power switch Q4 (e.g., the second bootstrap voltage V_{BST2} is delivered to the fourth power switch Q4 by way of a second driver (not shown)). The control circuit 201 comprises a bootstrap refresh circuit 11 and a control signal generator 12. When the buck boost converter 200 operates at a pass through mode, the bootstrap refresh circuit 11 is configured to periodically generate a refresh clock signal RCLK. The control signal generator 12 is configured to generate a first control signal G_{Q1}, a second control signal G_{Q2}, a third control signal G_{Q3} and a fourth control signal G_{Q4} in response to the refresh clock signal RCLK and a mode indicate signal, to respectively control the first power switch Q1, the second power switch Q2, the third power switch Q3 and the fourth power switch Q4.

In one embodiment of the present invention, the mode indicate signal comprises at least one of: a buck indicate signal BK indicating the buck boost converter 200 to enter buck mode when the input voltage is higher than the output voltage; a boost indicate signal BST indicating the buck boost converter 200 to enter boost mode when the input voltage is lower than the output voltage; and a buck-boost indicate BB signal indicating the buck boost converter 200 to enter buck-boost mode and/or a pass through indicate signal PT indicating the buck boost converter 200 to enter the pass through mode, when a voltage difference between the input voltage and the output voltage is lower than a certain voltage value (e.g., when the voltage difference between the input voltage and the output voltage is within a voltage window).

In the example of FIG. 2, an inductor L is coupled between the first switch pin SW1 and the second switch pin SW2, a first bootstrap capacitor C1 is coupled between the first switch pin SW1 and the first bootstrap pin BST1, and a second bootstrap capacitor C2 is coupled between the second switch pin SW2 and the second bootstrap pin BST2.

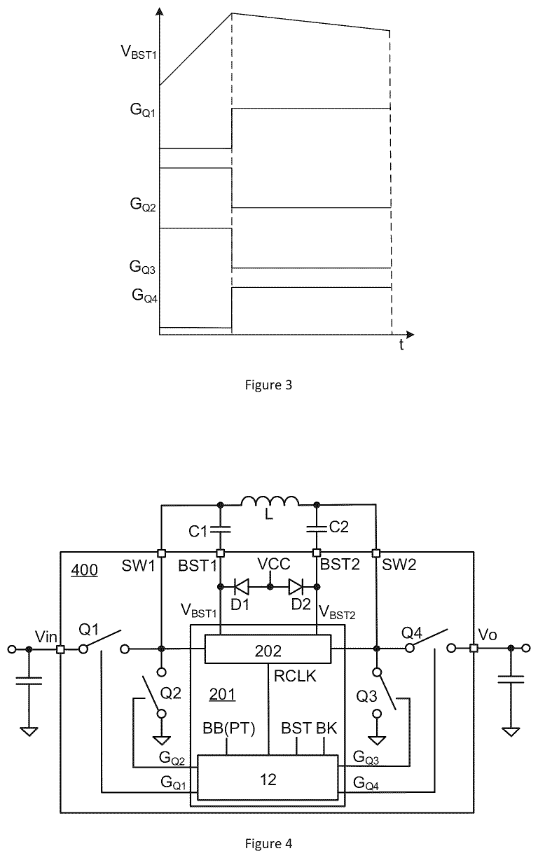

In one embodiment of the present invention, the control signal generator 12 is configured to control the first power switch Q1 to the fourth power switch Q4 to operate at a refresh mode in response to the refresh clock signal RCLK. The so-called refresh mode refers to: the first power switch Q1 and the fourth power switch Q4 are controlled to be OFF, and the second power switch Q2 and the third power switch Q3 are controlled to be ON for a first time period; and then the first power switch Q1 and the fourth power switch Q4 are controlled to be ON, and the second power switch Q2 and the third power switch Q3 are controlled to be OFF for a second time period. When the first power switch Q1 and the fourth power switch Q4 are turned on, and the second power switch Q2 and the third power switch Q3 are turned off, the first bootstrap capacitor C1 is charged by a power supply VCC via a diode D1 and the second power switch Q2, and the second bootstrap capacitor C2 is charged by the power supply VCC via a diode D2 and the third power switch Q3. Consequently, the first bootstrap voltage V_{BST1} and the second bootstrap voltage V_{BST2} both rise. When the first power switch Q1 and the fourth power switch Q4 are turned off, and the second power switch Q2 and the third power switch Q3 are turned on, the first bootstrap voltage V_{BST1} and the second bootstrap voltage V_{BST2} both fall. FIG. 3 schematically shows timing waveforms of the first bootstrap voltage V_{BST1}, the first control signal G_{Q1} to the fourth control signal G_{Q4} under the refresh mode in accordance with an embodiment of the present invention.

In one embodiment of the present invention, the refresh clock signal RCLK is generated periodically when the buck boost converter operates at the pass through mode. That is, the bootstrap refresh circuit is configured to generate the refresh clock signal RCLK periodically, to prevent the first bootstrap capacitor C1 and the second bootstrap capacitor C2 from entering an undervoltage condition.

In one embodiment of the present invention, the first time period and the second time period are both programmable, which may be set by the system (e.g., register). When the buck boost converter 200 operates at the pass through mode, the first time period may be set at a microsecond level (e.g., 0.5 microseconds), and the second time period may be set at a millisecond level (e.g., 1 millisecond).

In one embodiment of the present invention, when the buck boost converter 200 operates at the pass through mode, the first bootstrap voltage V_{BST1} and the second bootstrap voltage V_{BST2} may enter the undervoltage condition. The bootstrap refresh circuit is configured to generate the refresh clock signal RCLK in response to the undervoltage condition, to control the first power switch Q1 to the fourth power switch Q4 to operate at the refresh mode: the first power switch Q1 and the fourth power switch Q4 are controlled to be OFF, and the second power switch Q2 and the third power switch Q3 are controlled to be ON for the first time period; and then the first power switch Q1 and the fourth power switch Q4 are controlled to be ON, and the second power switch Q2 and the third power switch Q3 are controlled to be OFF for the second time period. The first time period may be set as hundreds of nanoseconds (e.g. 200 nanoseconds), and the second time period may be set as several milliseconds (e.g., 1.6 milliseconds).

In one embodiment of the present invention, when at least one of the first bootstrap voltage V_{BST1} and the second bootstrap voltage V_{BST2} enters the undervoltage condition, the bootstrap refresh circuit is configured to perform refresh at least one time. That is, the refresh clock signal would be generated at least for one switching cycle, so that the control circuit 201 is configured to control the first power switch to the fourth power switch to operate at the refresh mode at least for one switching cycle. Then, the buck boost converter 200 is configured to judge again whether the first bootstrap voltage V_{BST1} and the second bootstrap voltage V_{BST2} are still under the undervoltage condition. If at least one of the first bootstrap voltage V_{BST1} and the second bootstrap voltage V_{BST2} is still under the undervoltage condition, the bootstrap refresh circuit 11 is configured to continue performing refresh function, to continue generating the refresh clock signal RCLK, until both the first bootstrap voltage V_{BST1} and the second bootstrap voltage V_{BST2} exit from the undervoltage condition.

In one embodiment of the present invention, the buck boost converter 200 comprises an integrated circuit chip.

In one embodiment of the present invention, the power supply VCC is provided by a voltage converter (not shown). The voltage converter is configured to receive the input voltage and convert the input voltage to a voltage level conform to the integrated circuit chip.

FIG. 4 schematically shows a circuit configuration of the buck boost converter 400 in accordance with an embodiment of the present invention. In the example of FIG. 4, the undervoltage condition of the first bootstrap voltage V_{BST1} and the second bootstrap voltage V_{BST2} is monitored. Specifically, in the example of FIG. 4, the control circuit 201 comprises: a bootstrap manage circuit 202, coupled to the first switch pin SW1, the first bootstrap pin BST1, the second switch pin SW2, and the second bootstrap pin BST2, to monitor (or detect) the undervoltage conditions of the first bootstrap voltage V_{BST1} and the second bootstrap voltage V_{BST2}. When at least one of the first bootstrap voltage V_{BST1} and the second bootstrap voltage V_{BST2} has an undervoltage condition, the bootstrap manage circuit 202 is configured to generate the refresh clock signal RCLK, so that the first power switch Q1 to fourth power switch Q4 are controlled to operate at the refresh mode by the control circuit 201. Accordingly, the first power switch Q1 and the fourth power switch Q4 are controlled to be OFF, and the second power switch Q2 and the third power switch Q3 are controlled to be ON for the first time period; and then the first power switch Q1 and the fourth power switch Q4 are controlled to be ON, and the second power switch Q2 and the third power switch Q3 are controlled to be OFF for the second time period.

Then, the bootstrap manage circuit 202 monitors the undervoltage conditions of the first bootstrap voltage V_{BST1} and the second bootstrap voltage V_{BST2} again. If at least one of the first bootstrap voltage V_{BST1} and the second bootstrap voltage V_{BST2} is still under the undervoltage condition, the bootstrap manage circuit 202 is configured to provide the refresh clock signal RCLK again, so that the control circuit 201 continues to control the first power switch Q1 to the fourth power switch Q4 to operate at the refresh mode. If both the first bootstrap voltage V_{BST1} and the second bootstrap voltage V_{BST2} exit from the undervoltage condition, the bootstrap manage circuit 202 no longer provides the refresh clock signal RCLK. The control circuit 201 is configured to control the operations of the first power switch Q1 to the fourth power switch Q4 based on the mode indicate signal.

In one embodiment of the present invention, the bootstrap manage circuit 202 is configured to compare a voltage difference (i.e., a voltage across the first bootstrap capacitor C1) between the first bootstrap pin BST1 and the first switch pin SW1 with a threshold voltage, and compare a voltage difference (i.e., a voltage across the second bootstrap capacitor C2) between the second bootstrap pin BST2 and the second switch pin SW2 with the threshold voltage. If the voltage difference between the first bootstrap pin BST1 and the first switch pin SW1 is lower than a first threshold voltage, the undervoltage condition occurs at the first bootstrap voltage V_{BST1}. If the voltage difference between the second bootstrap pin BST2 and the second switch pin SW2 is lower than a second threshold voltage, the undervoltage condition occurs at the second bootstrap voltage V_{BST2}.

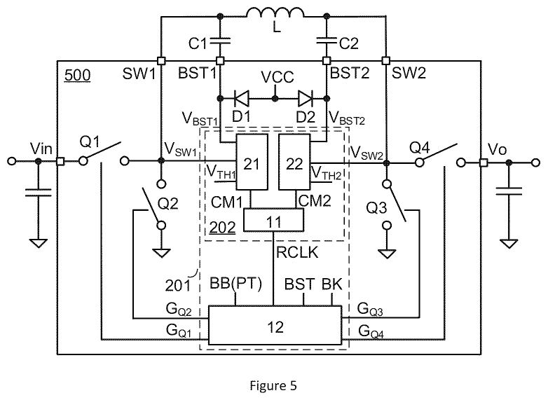

FIG. 5 schematically shows a circuit configuration of the buck boost converter 500 with a circuit configuration of the bootstrap manage circuit 202 in accordance with an embodiment of the present invention. As shown in FIG. 5, the bootstrap manage circuit 202 comprises: a first compare circuit 21, a second compare circuit 22 and the bootstrap refresh circuit 11. The first compare circuit 21 is configured to generate a first comparison signal CM1 in response to the voltage V_{SW1} at the first switch pin SW1, the first bootstrap voltage V_{BST1}, and the first threshold voltage V_{TH1}. The second compare circuit 22 is configured to generate a second comparison signal CM2 in response to the voltage V_{SW2} at the second switch pin SW2, the second bootstrap voltage V_{BST2}, and the second threshold voltage V_{TH2}. The bootstrap refresh circuit 11 is configured to generate the refresh clock signal RCLK in response to the first comparison signal CM1 or the second comparison signal CM2, so that the first power switch Q1 to the fourth power switch Q4 are controlled to operate at the pass through mode by the control circuit 201. That is: the first power switch Q1 and the fourth power switch Q4 are controlled to be OFF, and the second power switch Q2 and the third power switch Q3 are controlled to be ON for the first time period; and then the first power switch Q1 and the fourth power switch Q4 are controlled to be ON, and the second power switch Q2 and the third power switch Q3 are controlled to be OFF for the second time period.

In one embodiment of the present invention, the first threshold voltage V_{TH1} and the second threshold voltage V_{TH2} are programmable through system (e.g., register). The first threshold voltage V_{TH1} and the second threshold voltage V_{TH2} may have different voltage values, or they may be set as a same voltage value, e.g., V_{TH1}=V_{TH2}.

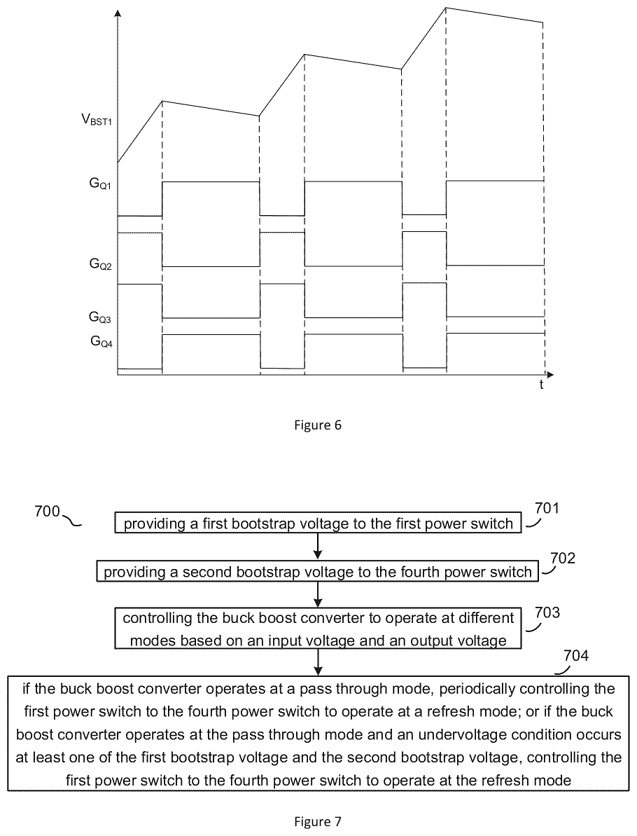

Specifically, when the voltage difference between the first bootstrap pin BST1 and the first switch pin SW1 is lower than the first threshold voltage V_{TH1}, i.e., when the undervoltage condition occurs at the first bootstrap pin BST1, the first comparison signal CM1 generated by the first compare circuit 21 is configured to have the bootstrap refresh circuit to generate the refresh clock signal RCLK. Or when the voltage difference between the second bootstrap pin BST2 and the second switch pin SW2 is lower than the second threshold voltage V_{TH2}, i.e., when the undervoltage condition occurs at the second bootstrap pin BST2, the second comparison signal CM2 generated by the second compare circuit 22 is configured to have the bootstrap refresh circuit to generate the refresh clock signal RCLK. The refresh clock signal RCLK may be generated for one switching cycle, as shown in FIG. 3, or the refresh clock signal RCLK may be generated for several switching cycles, as shown in FIG. 6, so as to lift the first bootstrap voltage V_{BST1} and/or the second bootstrap voltage V_{BST2} to desired voltage values.

As the turning-on of the second power switch Q2 and the third power switch Q3, the first bootstrap capacitor C1 and the second bootstrap capacitor C2 are charged. When the first bootstrap voltage V_{BST1} and the second bootstrap voltage V_{BST2} both increase to exit from the undervoltage condition, the refresh clock signal RCLK releases the control of the control circuit 201. Then the control signal generator 12 is configured to generate the first control signal to the fourth control signal based on the input voltage, the output voltage and the mode indicate signal, to control the first power switch Q1 to the fourth power switch Q4, so as to control the buck boost converter to operate at desired mode.

In one embodiment of the present invention, the first threshold voltage V_{TH1} and the second threshold voltage V_{TH2} are generated internally by the integrated circuit. The first compare circuit 21 and the second compare circuit 22 both have hysteresis. That is, when judging whether the first bootstrap voltage V_{BST1} is at the undervoltage condition, the first compare circuit 21 is configured to compare the voltage across the first bootstrap capacitor C1 with the first threshold voltage V_{TH1}, to generate the first comparison signal CM1; and when judging whether the first bootstrap voltage V_{BST1} exits from the undervoltage condition, the first compare circuit 21 is configured to compare the voltage across the first bootstrap capacitor C1 with a sum of the first threshold voltage V_{TH1} and a hysteresis voltage, to generate the comparison result. Similarly, when judging whether the second bootstrap voltage V_{BST2} is at the undervoltage condition, the second compare circuit 22 is configured to compare the voltage across the second bootstrap capacitor C2 with the second threshold voltage V_{TH2}, to generate the second comparison signal CM2; and when judging whether the second bootstrap voltage V_{BST2} exits from the undervoltage condition, the second compare circuit 22 is configured to compare the voltage across the second bootstrap capacitor C2 with a sum of the second threshold voltage V_{TH2} and the hysteresis voltage, to generate the comparison result.

In one embodiment of the present invention, when the undervoltage condition occurs at the first bootstrap pin BST1 or the second bootstrap pin BST2, the control circuit 201 is configured to 1) turn on the second power switch Q2 after a first time length since the turning-off of the first power switch Q1 and the fourth power switch Q4, and 2) turn on the third power switch Q3 after a second time length since the turning-off of the first power switch Q1 and the fourth power switch Q4, so as to prevent the first power switch Q1 and the second power switch Q2 from being turned on at the same time (or to prevent the third power switch Q3 and the fourth power switch Q4 from being turned on at the same time), to avoid shoot through.

In one embodiment of the present invention, the first time length and the second time length may be set by system, e.g., the first time length may be set around 40 nanoseconds, and the second time length may be set around 20 nanoseconds.

FIG. 7 schematically shows a flowchart 700 of a method used in a buck boost converter in accordance with an embodiment of the present invention. The buck boost converter comprises: an input pin, an output pin, a first switch pin, a first bootstrap pin, a second switch pin, and a second bootstrap pin. The input pin is configured to receive an input voltage. The output pin is configured to provide an output voltage. The first switch pin is configured to receive the input voltage via a first power switch and is coupled to a reference ground via a second power switch. The first bootstrap pin is configured to provide a first bootstrap voltage to the first power switch. The second switch pin is coupled to the reference ground via a third power switch and is coupled to the output pin via a fourth power switch. The second bootstrap pin is configured to provide a second bootstrap voltage to the fourth power switch. The method comprises:
Step 701, providing a first bootstrap voltage to the first power switch.
Step 702: providing a second bootstrap voltage to the fourth power switch.
Step 703, controlling the buck boost converter to operate at different modes based on the input voltage and the output voltage. And
Step 704, if the buck boost converter operates at a pass through mode, periodically controlling the first power switch to the fourth power switch to operate at a refresh mode; or if the buck boost converter operates at the pass through mode and an undervoltage condition occurs at least one of the first bootstrap voltage and the second bootstrap voltage, controlling the first power switch to the fourth power switch to operate at the refresh mode. The refresh mode may be triggered by a refresh clock signal. That is, the refresh clock signal is configured to control the first power switch to the fourth power switch to operate at a refresh mode: the first power switch and the fourth power switch are controlled to be OFF, and the second power switch and the third power switch are controlled to be ON for a first time period; and then the first power switch and the fourth power switch are controlled to be ON, and the second power switch and the third power switch are controlled to be OFF for a second time period.

In one embodiment of the present invention, the method further comprises: detecting whether the first bootstrap voltage and the second bootstrap voltage both exit from the undervoltage condition after the second time period. If at least one of the first bootstrap voltage and the second bootstrap voltage does not exit from the undervoltage condition, continuing controlling the first power switch to the fourth power switch to operate at the refresh mode; and if the first bootstrap voltage and the second bootstrap voltage both exit from the undervoltage condition, stopping controlling the first power switch to the fourth power switch to operate at the refresh mode.

In one embodiment of the present invention, the method further comprises: when the undervoltage condition occurs at least one of the first bootstrap voltage and the second bootstrap voltage, turning on the second power switch after a first time length since the first power switch and the fourth power switch are turned off, and turning on the third power switch after a second time length since the first power switch and the fourth power switch are turned off.

In one embodiment of the present invention, the operation mode of the buck boost converter comprises: buck mode, boost mode, buck-boost mode, and the pass though mode.

Several embodiments of the foregoing buck boost converter and the method generate refresh clock signal periodically when the converter operates at the pass through mode, so that the first bootstrap capacitor and the second bootstrap capacitor are charged timely, which prevent the first bootstrap pin and the second bootstrap pin from being undervoltage. And when the converter operates at the pass through mode, if the undervoltage condition occurs at least one of the first bootstrap pin and the second bootstrap pin, the first power switch and the fourth power switch are turned off, and the second power switch and the third power switch are turned on, so that the first bootstrap capacitor and the second bootstrap capacitor are charged, which ensure the normal operation of the converter. Several embodiments of the forgoing buck boost converter simplify the circuit design, which highly reduce the layout size.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. A buck boost converter, comprising:
an input pin, configured to receive an input voltage;
a first switch pin, 1) configured to receive the input voltage via a first power switch and 2) coupled to a reference ground via a second power switch;
a first bootstrap pin, configured to provide a first bootstrap voltage to the first power switch;
an output pin, configured to provide an output voltage;
a second switch pin, coupled to 1) the reference ground via a third power switch and 2) the output pin via a fourth power switch;
a second bootstrap pin, configured to provide a second bootstrap voltage to the fourth power switch; and
a control circuit, having a bootstrap refresh circuit and a control signal generator; wherein:
when the buck boost converter operates at a pass through mode, the bootstrap refresh circuit is configured to periodically generate a refresh clock signal, and the control signal generator is configured to generate a first control signal, a second control signal, a third control signal, and a fourth control signal in response to the refresh clock signal and a mode indicate signal, to respectively control the first power switch, the second power switch, the third power switch, and the fourth power switch.

2. The buck boost converter of claim 1, wherein the control signal generator is configured to control the first power switch to the fourth power switch to operate at a refresh mode in response to the refresh clock signal.

3. The buck boost converter of claim 2, wherein the refresh mode comprises:
the first power switch and the fourth power switch are controlled to be OFF, and the second power switch and the third power switch are controlled to be ON for a first time period; and
then the first power switch and the fourth power switch are controlled to be ON, and the second power switch and the third power switch are controlled to be OFF for a second time period.

4. The buck boost converter of claim 2, wherein:
when the buck boost converter operates at the pass through mode and an undervoltage condition occurs at least one of the first bootstrap voltage and the second bootstrap voltage, the bootstrap refresh circuit is configured to generate the refresh clock signal for at least one switching cycle, to control the first power switch to the fourth power switch to operate at the refresh mode for at least one switching cycle.

5. The buck boost converter of claim 4, wherein:
the buck boost converter is configured to judge again whether the first bootstrap voltage and the second bootstrap voltage are still under the undervoltage condition after the first power switch to the fourth power switch operating at the refresh mode for at least one switching cycle:
if at least one of the first bootstrap voltage and the second bootstrap voltage is still under the undervoltage condition, the bootstrap refresh circuit is configured to continue generating the refresh clock signal, to control the first power switch to the fourth power switch to continue operating at the refresh mode, until both the first bootstrap voltage and the second bootstrap voltage exit from the undervoltage condition.

6. The buck boost converter of claim 1, wherein the mode indicate signal comprises at least one of:
a buck indicate signal, a boost indicate signal, a buck-boost indicate signal and a pass through indicate signal.

7. The buck boost converter of claim 1, further comprising:
a bootstrap manage circuit, configured to detect the undervoltage conditions of the first bootstrap voltage and the second bootstrap voltage.

8. The buck boost converter of claim 7, wherein the bootstrap manage circuit comprises:
a first compare circuit, configured to generate a first comparison signal in response to a voltage at the first switch pin, the first bootstrap voltage, and a first threshold voltage;
a second compare circuit, configured to generate a second comparison signal in response to a voltage at the second switch pin, the second bootstrap voltage, and a second threshold voltage; and
the bootstrap refresh circuit, configured to generate the refresh clock signal in response to the first comparison signal or the second comparison signal.

9. A buck boost converter, comprising:
an input pin, configured to receive an input voltage;
a first switch pin, 1) configured to receive the input voltage via a first power switch and 2) coupled to a reference ground via a second power switch;
a first bootstrap pin, configured to provide a first bootstrap voltage to the first power switch;
an output pin, configured to provide an output voltage;
a second switch pin, coupled to 1) the reference ground via a third power switch and 2) the output pin via a fourth power switch;
a second bootstrap pin, configured to provide a second bootstrap voltage to the fourth power switch; and
a control circuit, having a bootstrap manage circuit, coupled to the first switch pin, the first bootstrap pin, the second switch pin, and the second bootstrap pin, to monitor a undervoltage condition of the first bootstrap voltage and the second bootstrap voltage, wherein when at least one of the first bootstrap voltage and the second bootstrap voltage has the undervoltage condition, the bootstrap manage circuit is configured to control the first power switch to fourth power switch to operate at a refresh mode.

10. The buck boost converter of claim 9, wherein the refresh mode comprises:
the first power switch and the fourth power switch are controlled to be OFF, and the second power switch and the third power switch are controlled to be ON for a first time period; and
then the first power switch and the fourth power switch are controlled to be ON, and the second power switch and the third power switch are controlled to be OFF for a second time period.

11. The buck boost converter of claim 10, wherein:
the bootstrap manage circuit is configured to monitor the under voltage condition of the first bootstrap voltage and the second bootstrap voltage again after the second time period is over,
if at least one of the first bootstrap voltage and the second bootstrap voltage is still under the undervoltage condition, the bootstrap manage circuit is configured to control the first power switch to the fourth power switch to operate at the refresh mode again, until both the first bootstrap voltage and the second bootstrap voltage exit from the undervoltage condition.

12. The buck boost converter of claim 9, wherein the bootstrap manage circuit comprises:
a first compare circuit, configured to generate a first comparison signal in response to a voltage at the first switch pin, the first bootstrap voltage, and a first threshold voltage;
a second compare circuit, configured to generate a second comparison signal in response to a voltage at the second switch pin, the second bootstrap voltage, and a second threshold voltage; and
a bootstrap refresh circuit, configured to generate the refresh clock signal in response to the first comparison signal or the second comparison signal.

13. The buck boost converter of claim 9, wherein the control circuit is configured to control the first power switch to the fourth power switch to operate at different modes based on a mode indicate signal.

14. The buck boost converter of claim 13, wherein the mode indicate signal comprises at least one of:
a buck indicate signal, a boost indicate signal, a buck-boost indicate signal and a pass through indicate signal.

15. The buck boost converter of claim 9, wherein:
when at least one of the first bootstrap voltage and the second bootstrap voltage has the undervoltage condition, the bootstrap manage circuit is configured to generate a refresh clock signal, to control the first power switch to fourth power switch to operate at the refresh mode.

16. A method used in a buck boost converter, the buck converter having a first power switch, a second power switch, a third power switch, and a fourth power switch, the method comprising:
providing a first bootstrap voltage to the first power switch;
providing a second bootstrap voltage to the fourth power switch;
controlling the buck boost converter to operate at different modes based on an input voltage and an output voltage; and
if the buck boost converter operates at a pass through mode, periodically controlling the first power switch to the fourth power switch to operate at a refresh mode; or if the buck boost converter operates at the pass through mode and an undervoltage condition occurs at least one of the first bootstrap voltage and the second bootstrap voltage, controlling the first power switch to the fourth power switch to operate at the refresh mode.

17. The method of claim 16, wherein the refresh mode comprises:
the first power switch and the fourth power switch are controlled to be OFF, and the second power switch and the third power switch are controlled to be ON for a first time period; and
then the first power switch and the fourth power switch are controlled to be ON, and the second power switch and the third power switch are controlled to be OFF for a second time period.

18. The method of claim 17, further comprising:
detecting whether the first bootstrap voltage and the second bootstrap voltage both exit from the undervoltage condition after the second time period is over, If at least one of the first bootstrap voltage and the second bootstrap voltage does not exit from the undervoltage condition, continuing controlling the first power switch to the fourth power switch to operate at the refresh mode; and if the first bootstrap voltage and the second bootstrap voltage both exit from the undervoltage condition, stopping controlling the first power switch to the fourth power switch to operate at the refresh mode.

19. The method of claim 17, further comprising:
when the undervoltage condition occurs at least one of the first bootstrap voltage and the second bootstrap voltage, turning on the second power switch after a first time length since the first power switch and the fourth power switch are turned off, and turning on the third power switch after a second time length since the first power switch and the fourth power switch are turned off.

20. The method of claim 16, wherein the operation mode of the buck boost converter comprises at least one of:
buck mode, boost mode, buck-boost mode, and the pass though mode.
